(19) United States
(12) Patent Application Publication
(10) Pub. No.: US 2023/0161017 A1
(43) Pub. Date: May 25, 2023

(54) Optoelectronic sensor

(71) Applicant: SICK AG, Waldkirch (DE)

(72) Inventors: Christoph MENZEL, Waldkirch (DE); Boris BALDISCHWEILER, Waldkirch (DE)

(21) Appl. No.: 17/989,982

(22) Filed: Nov. 18, 2022

(30) Foreign Application Priority Data
Nov. 19, 2021 (DE) 102021130334.6

(51) Int. Cl. G01S 7/497; G01S 7/481; G01S 7/4861; G01S 7/486

(52) U.S. Cl. CPC G01S 7/497; G01S 7/4811; G01S 7/4861; G01S 7/4868

(57) ABSTRACT

An optoelectronic sensor is provided having at least one measurement light source for transmitting at least one measurement light beam in the infrared wavelength range into a monitored zone; at least one pilot light source for transmitting at least one pilot light beam in the visible wavelength range into the monitored zone; an optical element for the coaxial superposition of the measurement light beam and of the pilot light beam; a light receiver for receiving measurement light beams remitted or reflected from the monitored zone and for generating corresponding received signals; and a control and evaluation unit for controlling the light receiver, the measurement light source, and/or the pilot light source and for evaluating the received signals, wherein the optical element for the coaxial superposition of the measurement light beam and of the pilot light beam has at least one first optical metasurface.

The invention relates to an optoelectronic sensor for detecting an object in a monitored zone.

Many optoelectronic sensors work in accordance with the sensing principle in which a light beam is transmitted into the monitored zone and the light beam reflected by an object is received again in order then to electronically evaluate the received signal, for example for a distance measurement. The time of flight is here often measured using a known phase method or pulse method to determine the distance of a sensed object. Optoelectronic sensors that use this method are frequently called light sensors, TOF (time of flight) sensors, or LIDAR (light detection and ranging) sensors. To expand the measured zone, the light beam can be moved, as is the case in a laser scanner. A light beam generated by a laser there periodically sweeps over the monitored zone with the help of a deflection unit. In addition to the measured distance information, a conclusion is drawn on the angular location of the object from the angular position of the deflection unit and the site of an object in the monitored zone is thus detected in two-dimensional polar coordinates. The scanning movement is achieved by a rotating mirror in most laser scanners. It is, however, also known to instead have the total measurement head with light transmitters and light receivers rotate.

Optoelectronic sensor of the initially named kind can work with visible light, but also with light in the infrared wavelength range. The use of infrared light has the advantage that the measurement is not perceived as irritating. In addition, light sources that emit infrared light, for example vertical cavity surface emitting lasers (VCSELs), are available in smaller sizes than laser diodes that emit visible light. A sensor can therefore be built as correspondingly smaller.

An infrared signal, however, has the disadvantage that the detection zone, in particular the specific location of the distance measurement on the respective surface, cannot be recognized by the human eye without additional aids, which in particular makes the assembly and the adjustment of the sensor more difficult.

A visible so-called pilot or target beam is therefore superposed on the infrared measurement beam, typically using a dichroitic mirror such as described in US 2004/0070745 A1. Such systems are, however, comparatively large and the adjustment of the measurement beam and the pilot mean is moreover complex and prone to losses of adjustment.

Starting from this prior art, it is the object of the invention to provide an improved optoelectronic sensor which has a compact and robust construction.

This object is satisfied by an optoelectronic senor having the features of claim 1.

The optoelectronic sensor in accordance with the invention has at least one measurement light source for transmitting at least one measurement light beam in the infrared wavelength range. Light beams are here not to be understood as beams in the sense of geometrical optics within a larger bundle of rays, but rather as light beams that generate corresponding light spots in the monitored zone on incidence on an object. An associated light receiver is able to generate received signals from reflected or remitted measurement light beams.

A control and evaluation unit controls the light sources and the light receiver and can evaluate the received signals of the light receiver to acquire information on the object such as a distance from the sensor.

To align the infrared measurement light beam that is invisible to the human eye, at least one pilot light beam is provided that is transmitted from a pilot light source in the visible wavelength range and at least one optical element for a coaxial overlapping of the measurement light beam and the pilot light beam so that they are projected into the monitored zone coaxially along an optical axis of the optoelectronic sensor and there generate substantially overlapping light spots.

The invention starts from the basic idea that the optical element for the coaxial superposition of the measurement light beam and of the pilot light beam has at least one first optical metasurface. This has the advantage that an improved sensor design with smaller space requirements and a more robust optics can be implemented.

Metasurfaces in the sense of this application are to be understood as optically effective layers that have structures having structure sizes smaller than the wavelengths of the measurement light beam and that typically have a binary height profile. Such surfaces are known from the technical literature (e.g.: Flat optics with designer metasurfaces, Nature Mater 13, 139 -150 (2014). DOI: 10.1038/NMAT3839) and, by a suitable choice of the structures, can vary properties of the measured light beams or pilot light beams such as the phase, amplitude, and thus the propagation direction and the polarization by imparting a phase profile, in particular in dependence on the wavelength of the light beams. Metasurfaces are also called “flat optics” since their space requirements in the beam direction are considerably smaller than that of conventional refractive optics.

In an embodiment of the invention, the first optical metasurface can be configured to set an aperture angle of the measurement light beam by imparting a substantially parabolic phase profile. A refractive lens typically used for this purpose and arranged downstream of the measurement light source can thereby be dispensed with and thus construction space saved. The measurement light beam can in particular be collimated by the first optical metasurface so that a parallel measurement light beam bundle is generated.

In a further embodiment of the invention, the first optical metasurface can be configured to set an aperture angle of the pilot light beam by imparting a substantially parabolic phase profile. A refractive lens typically used for this purpose and arranged downstream of the pilot light source can thereby be dispensed with and thus construction space saved. The measurement light pilot light beam can in particular be collimated by the first optical metasurface so that a parallel measurement light beam bundle is generated.

In a preferred embodiment of the invention, the optical element for the superposition of the measurement light beam and of the pilot light beam has at least one first and one second metasurface, with the first optical metasurface being able to be configured to set an aperture angle of the measurement light beam by imparting a first substantially parabolic phase profile and the second optical metasurface being able to be configured to set an aperture angle of the pilot light beam by imparting a second substantially parabolic phase profile. The optical element can particularly preferably have a dichroitic beam combiner to coaxially superpose the measurement light beam and the pilot light beam. A particularly effective beam combination by the dichroitic beam combiner, for example a Bragg mirror, is possible by the collimation of the measurement light beam and the pilot light beam since the transmission conditions or the reflection conditions (design of the layer structure of the Bragg mirror) only have to be optimized for an angle of incidence of the measurement light beam or pilot light beam on the dichroitic beam combiner.

The dichroitic beam combiner can be configured as a beam combiner cube, with the optical metasurfaces preferably being able to be applied directly to the light entry surfaces of the beam combiner cube.

In an alternative embodiment of the invention, the first optical metasurface can be configured to coaxially superpose the measurement light beam and the pilot light beam. A dichroitic mirror can thus be dispensed with. The measurement light beam can here be incident on the optical metasurface at a first angle and the pilot light beam can be incident thereon at a second angle with respect to the optical axis of the sensor along which the measurement light beam and the pilot light beam are projected into the monitored zone, with amounts and/or directions of the first and second angles being able to differ. The optical axes along which the measurement light beam and the pilot light beam propagate to the optical metasurface can preferably intersect at the optical metasurface. The optical metasurface is configured such that the measurement light beam or pilot light beam are deflected by different amounts, are coaxially superposed, and projected into the monitored zone along the optical axis of the sensor by imparting wavelength dependent, substantially wedge shaped phase profiles from the optical metasurface.

In a further embodiment of the invention, the first optical metasurface can additionally be configured to set, preferably to collimate, an aperture angle of the measurement light beam or of the pilot light beam by imparting a wavelength dependent, substantially parabolic phase profile. Additional optical elements such as refractive lenses or further optical metasurfaces for setting an aperture angle of the measured light beam and/or pilot light beam can thus be dispensed with.

In the different embodiments, an optical beam shaping element for varying a shape of the beam cross-section of the pilot light beam can be arranged downstream of the pilot light beam in the beam direction. The optical beam shaping element can be configured, for example, such that pilot light beams generate cruciform light spots on an incidence on an object in the monitored zone. The alignment of the sensor can be further simplified by a corresponding light spot shape. The optical beam shaping element can be configured as a diffractive optical element or as a further metasurface. The beam shaping can, however, also take place by a corresponding configuration of the first metasurface for combining the measurement light beam and pilot light beam.

The measurement light source and the pilot light source can be arranged on a common circuit board. They can be aligned such that the optical axes along which the measurement light beam and pilot light beam are emitted by the light sources have an angle from one another and intersect at the optical element for the superposition of the measurement light beam and of the pilot light beam. The light sources can, however, also be aligned such that the optical axes along which the measurement light beam or the pilot light beam is emitted extend in parallel, with an optical element for the deflection of the measurement light beam and/or the pilot light beam then being arranged downstream of the measurement light source and/or the pilot light source and being configured such that the optical axes along which the measurement light beam and the pilot light beam propagate to the optical element for the superposition of the measurement light beam and the pilot light beam intersect thereat.

The pilot light source can emit at least one pilot light beam having a wavelength adapted to the light sensitivity of the human eye. Green light at a wavelength of 550 nm, for example, is perceived as 31 times brighter for the human eye than red light at a wavelength of 670 nm. When green light is used, a pilot light source having a smaller power can therefore be used.

A reception optics for focusing reflected or remitted measurement light beams onto the light receiver can be arranged upstream of the light receiver. The reception optics can be designed as a metasurface and can be configured such that only reflected or remitted measurement light beams are imaged on the sensor and light beams from different wavelength ranges are deflected away from the light receiver, for example a beam trap. The reception optics then acts in a similar manner to an optical filter.

Alternatively or additionally, an optical filter for the suppression of interference light, in particular of reflected or remitted pilot light beams can be arranged upstream of the light receiver. The optical filter can likewise be configured as a metasurface.

The control and evaluation unit of the sensor can be adapted to provide different operating modes of the sensor. One operating mode can, for example, be an adjustment mode in which the measurement light beam and the pilot light beam are activated simultaneously. A further operating mode can be a measurement mode in which the pilot light beam has been deactivated so that interference light generated by the pilot light beam is reduced for the light receiver.

In accordance with a further development, the optoelectronic sensor is configured to determine the distance of the respective surface from the sensor from a time of flight of a pulsed light signal to the respective surface and back or from the phase shift of a modulated light signal transmitted by the sensor with respect to the light signal reflected at the respective surface. The optoelectronic sensor can therefore in particular work in accordance with the time of flight (TOF) principle.

The invention will be explained in detail in the following with reference to an embodiment and to the drawing. There are shown in the drawing:

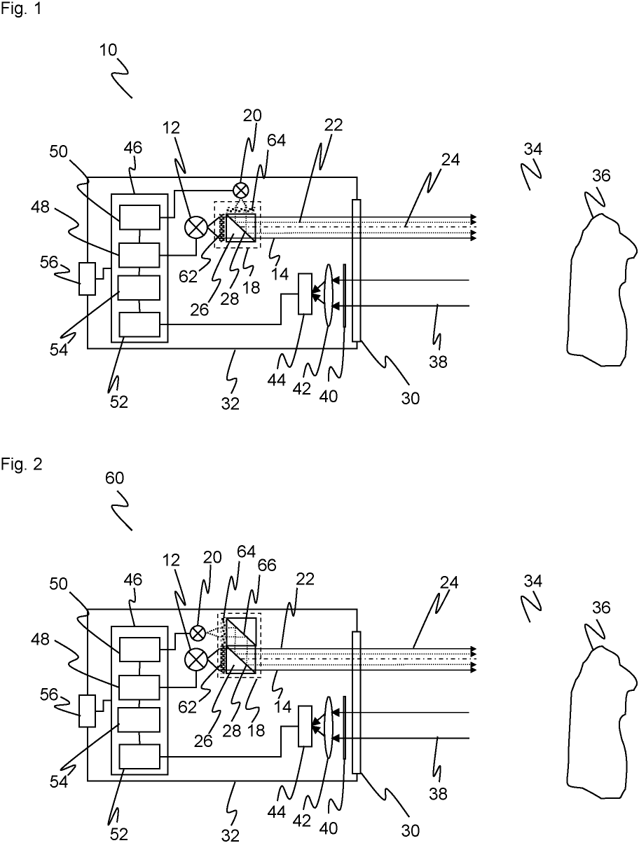

FIG. 1 a schematic representation of an optoelectronic sensor in accordance with the invention;

FIG. 2 a schematic representation of an alternative embodiment of an optoelectronic sensor in accordance with the invention;

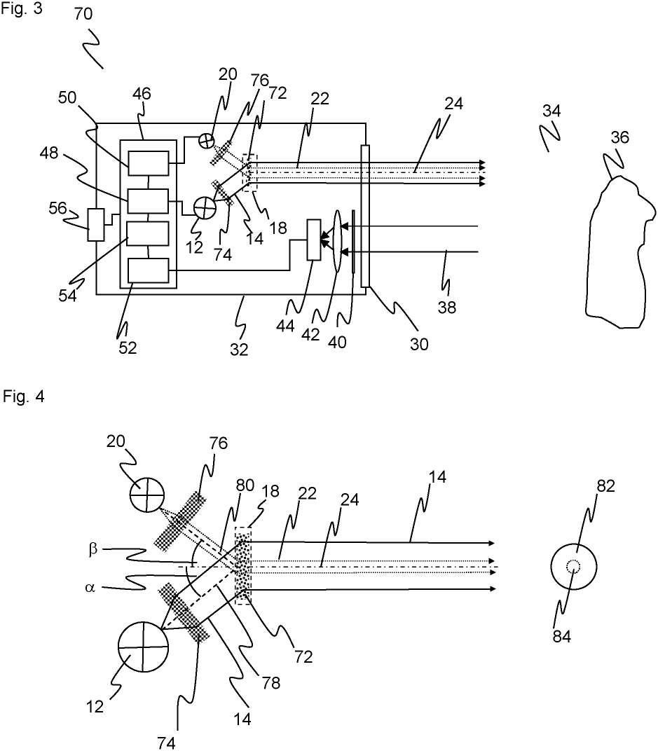

FIG. 3 a schematic representation of a further embodiment of an optoelectronic sensor in accordance with the invention;

FIG. 4 a schematic representation of the function of an optical metasurface for the coaxial superposition of the measurement light beam and of the pilot light beam;

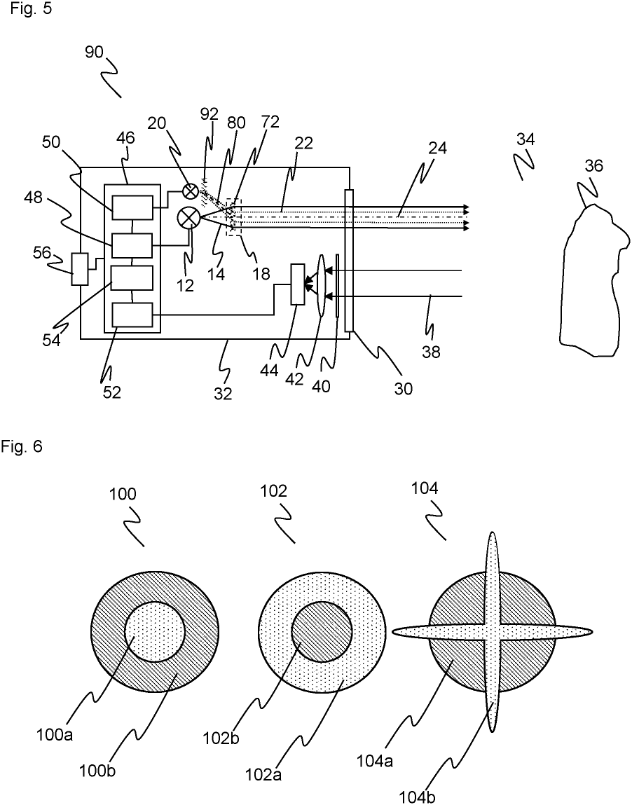

FIG. 5 a schematic representation of a further embodiment of an optoelectronic sensor in accordance with the invention; and

FIG. 6 exemplary light spots of measurement light beams and pilot light beams on an incidence on an object in the monitored zone.

FIG. 1 shows a schematic representation of an optoelectronic sensor 10 in accordance with the invention in an embodiment as a light sensor. The sensor 10 has a measurement light source 12, for example a laser diode or a vertical cavity surface emitting laser (VCSEL) that emits at least one measurement light beam 14 in the infrared wavelength range. The sensor 10 furthermore has a pilot light source 20, for example a light emitting diode (LED) that emits at least one pilot light beam 22 in the visible wavelength range.

An optical element 18 is configured as a beam combiner cube 26 having a dichroitic beam combiner 28 that transmits the measurement light beam 14 and reflects the pilot light beam 22. The measurement light beam 14 and the pilot light beam 22 are thus coaxially superposed by the optical element 18 and are projected through a window 30 in the housing 32 of the sensor 10 into a monitored zone 34 along an optical axis 24 of the sensor 10.

The optical element 13 moreover has a first optical metasurface 62 and a second optical metasurface 64, with the first optical metasurface 62 being configured to collimate the measurement light beam 14 and the second optical metasurface 64 being configured to collimate the pilot light beam 22 so that the measurement light beam 14 and the pilot light beam 22 are incident on the dichroitic beam combiner 28 as collimated beams.

The measurement light beams remitted or remitted at an object 36 in the monitored zone 34 are conducted as received light 38 through a reception optics 42 onto a light receiver 44 via an optical filter 40 for the suppression of interference light.

The light receiver 44 is preferably formed as a photodiode, APD (avalanche photodiode), or SPAD (single photon avalanche diode), or SPAD matrix (SPAD array).

A control and evaluation unit 46 that is connected to the measurement light source 12, to the pilot light source 20, and to the light receiver 44 is furthermore provided in the sensor 10. The control and evaluation unit 46 comprises a measurement light source control 48, a pilot light source control 50, a time of flight measuring unit 52, and an object distance estimation unit 54, with them initially only being functional blocks that can also be implemented on the same hardware or in other functional units such as in the light sources 12,, 20 or in the light receiver 44. The evaluation unit 46 can output measured data via an interface 56 or can conversely accept control and parameterization instructions. The control and evaluation unit 46 can also be arranged in the form of local evaluation structures on a chip of the light receiver 12 or can interact as a partial implementation with the functions of a central evaluation unit (not shown).

The control and evaluation unit 46 can be designed to activate and deactivate the pilot light source 20 and the measurement light source 12 independently of one another.

FIG. 2 shows a schematic representation of an alternative embodiment of an optoelectronic sensor 60 in accordance with the invention. Unlike the sensor 10 shown in FIG. 1, the measurement light source 12 and the pilot light source 20 are arranged next to one another such that the measurement light beam 14 and the pilot light beam 22 are first irradiated in parallel with one another. The optical element 18 for the coaxial superposition of the measurement light beam 14 and of the pilot light beam 22 therefore has an additional surface 66, for example a mirror, for the deflection of the pilot light beam 22 onto the dichroitic beam combiner 28. The arrangement of the measurement light source 12 and the pilot light source 20 next to one another has the advantage, for example, that the light sources can be mounted on a common circuit board. The detection of the measurement light beams remitted or reflected at the object 36 in the monitored zone 34 takes place as in the embodiment described in FIG. 1.

FIG. 3 shows a further embodiment of an optoelectronic sensor 70 in accordance with the invention in which a first optical metasurface 72 of the optical element 18 for the coaxial superposition of the measurement light beam 14 and of the pilot light beam 22 is configured as a beam combiner of the measurement light beam 14 and the pilot light beam 22. The function of the optical metasurface 72 will be explained further in the following FIG. 4. A respective second optical metasurface 74 or a third optical metasurface 76 for the collimation of the measurement light beam 14 or of the pilot light beam 22 is arranged downstream of the measurement light source 14 or of the pilot light source 20 in the light beam direction. The collimated measurement light beam 14 and pilot light beam 22 are combined by the metasurface 72, are coaxially superposed, and are projected through the window 30 of the sensor 70 into the monitored zone 34 along of the optical axis 24 of the sensor 70. The detection of the measurement light beams remitted or reflected at the object 36 in the monitored zone 34 takes place as in the optoelectronic sensor 10 described in FIG. 1.

FIG. 4 shows by way of example the function of the first optical metasurface 72 of the optical element 18 for the coaxial superposition of the measurement light beam 14 and of the pilot light beam 22 from FIG. 3. The measurement light source 12 emits a measurement light beam 14 that is collimated by a second optical metasurface 74 by imparting a substantially parabolic first phase profile and is incident on the first optical metasurface 72 along a measurement light beam axis 78 at a first angle α with respect to the optical axis 24 of the sensor 70. The pilot light source 20 emits a pilot light beam 22 that is collimated by a third optical metasurface 76 by imparting a substantially parabolic second phase profile and is incident on the first optical metasurface 72 along a pilot light beam axis 80 at a second angle β with respect to the optical axis 24 of the sensor 70. The measurement light beam axis 78, the pilot light beam axis 80, and the optical axis 24 of the sensor 70 intersect at the first optical metasurface 72. The first optical metasurface 72 is configured such that it imparts a substantially wedge-shaped phase profile on the measurement light beam 14 and on the pilot light beam 20, independently of the wavelength in each case, said wedge-shaped phase profile resulting in a deflection of the measurement light beam 14 and the pilot light beam 20 so that they are projected into the monitored zone 34 coaxially along the optical axis 24 of the sensor 70 after the first optical metasurface 72 and there generate a measurement light beam spot 82 with a pilot light beam spot 84 arranged concentrically thereto on the incidence on an object.

The collimation function of the second and/or third optical metasurface or metasurfaces 74, 76 can also be integrated in the first optical metasurface 72. In this embodiment, the first optical metasurface 72 is configured such that they can respectively impart a wavelength dependent parabolic and/or wedge-shaped phase profile on the measurement light beam 14 and the pilot light beam 20.

In the exemplary sensor 90 shown in FIG. 5, a substantially parabolic phase profile is imparted on the measurement light beam 14 by the first optical metasurface 72 and the measurement light beam 14 is collimated. Since the measurement light beam 14 has already been emitted along the optical axis 24 of the sensor 90 by the measurement light source 12, no deflection of the measurement light beam 14 is necessary so that no wedge-shaped phase profile has to be imparted on the measurement light beam 14. The pilot light beam 22 that is initially emitted by the pilot light source 20 in parallel with the optical axis 24 of the sensor 90 is deflected by an optical deflection element 92, for example a mirror, a prism, or a further optical metasurface, in the direction of the first optical metasurface 72 so that it is incident on the first optical metasurface 72 along a pilot light beam axis 80 at a second angle β with respect to the optical axis 24 of the sensor 90. The pilot light beam axis 80, and the optical axis 24 of the sensor 90 intersect at the first optical metasurface 72. The first optical metasurface 72 is configured such that it imparts a substantially wedge-shaped and parabolic phase profile on the pilot light beam 20 so that the pilot light beam 20 is collimated and deflected. The measurement light beam 14 and the pilot light beam 20 are thereby projected into the monitored zone 34 coaxially along the optical axis 24 of the sensor 90 after the first optical metasurface 72. The detection of the measurement light beams remitted or reflected at the object 36 in the monitored zone 34 again takes place as in the embodiment described in FIG. 1.

FIG. 6 shows exemplary light spots 100, 102, 104 of measurement light beams and pilot light beams on an incidence on an object in the monitored zone. In the first exemplary light spot 100, the pilot light beam spot 100b is arranged concentrically in the measurement light beam spot 100a; in the second exemplary light spot 102, the pilot light beam spot 92b is configured and is arranged concentrically about the measurement light beam spot 92a. The third exemplary light spot 104 shows a cruciform pilot light beam spot 104b that is arranged centrally above a circular measurement light beam spot 104a. It is understood that the representations are purely exemplary; the light beam spots generated in the monitored zone are in particular not sharply defined as a rule.

The shape of the light spots 100, 102 can take place, for example, by a corresponding setting of the beam diameter of the measurement light beams and of the pilot light beams. A cruciform pilot light beam spot 104b can be generated by diffractive elements for beam shaping known from the prior art or by a further optical metasurface formed for a corresponding beam shaping.

1. An optoelectronic sensor comprising:
at least one measurement light source for transmitting at least one measurement light beam in the infrared wavelength range into a monitored zone;
at least one pilot light source for transmitting at least one pilot light beam in the visible wavelength range into the monitored zone;
an optical element for the coaxial superposition of the measurement light beam and of the pilot light beam;
a light receiver for receiving measurement light beams remitted or reflected from the monitored zone and for generating corresponding received signals; and
a control and evaluation unit for controlling the light receiver, the measurement light source and/or the pilot light source and for evaluating the received signals,
wherein the optical element for the coaxial superposition of the measurement light beam and of the pilot light beam has at least one first optical metasurface.

2. The optoelectronic sensor in accordance with claim 1, wherein the first optical metasurface is configured to set an aperture angle of the measurement light beam.

3. The optoelectronic sensor in accordance with claim 1, wherein the first optical metasurface is configured to set an aperture angle of the measurement light beam for the collimation of the measurement light beam.

4. The optoelectronic sensor in accordance with claim 1, wherein the first optical metasurface is configured to set an aperture angle of the pilot light beam.

5. The optoelectronic sensor in accordance with claim 1, wherein the first optical metasurface is configured to set an aperture angle of the pilot light beam for the collimation of the pilot light beam.

6. The optoelectronic sensor in accordance with claim 1, wherein the optical element has a second optical metasurface, wherein the first optical metasurface is configured to set an aperture angle of the measurement light beam, and the second optical metasurface is configured to set an aperture angle of the pilot light beam.

7. The optoelectronic sensor in accordance with claim 6, wherein the first optical metasurface is configured to set the aperture angle of the measurement light beam for the collimation of the measurement light beam.

8. The optoelectronic sensor in accordance with claim 6, wherein the second optical metasurface is configured to set the aperture angle of the pilot light beam for the collimation of the pilot light beam.

9. The optoelectronic sensor in accordance with claim 1, wherein the optical element for the coaxial superposition of the measurement light beam and of the pilot light beam has a dichroitic beam combiner.

10. The optoelectronic sensor in accordance with claim 1, wherein the first optical metasurface is configured for the coaxial superposition of the measurement light beam and of the pilot light beam.

11. The optoelectronic sensor in accordance with claim 10, wherein a second optical metasurface for the setting of an aperture angle of the measurement light beam is arranged downstream of the measurement light source in the light beam direction.

12. The optoelectronic sensor in accordance with claim 11, wherein the second optical metasurface for the setting of the aperture angle of the measurement light beam is arranged for the collimation of the measurement light beam.

13. The optoelectronic sensor in accordance with claim 11, wherein wherein a third optical metasurface for the setting of an aperture angle of the pilot light beam is arranged downstream of the pilot light source in the light beam direction.

14. The optoelectronic sensor in accordance with claim 12, wherein the third optical metasurface is arranged for the setting of the aperture angle of the pilot light beam for the collimation of the pilot light beam.

15. The optoelectronic sensor in accordance with claim 10, wherein the first optical metasurface is configured to set an aperture angle of the measurement light beam, and/or to set an aperture angle of the pilot light beam.

16. The optoelectronic sensor in accordance with claim 14, wherein the first optical metasurface is configured to set the aperture angle of the measurement light beam for the collimation of the measurement light beam, and/or to set the aperture angle of the pilot light beam for the collimation of the pilot light beam.

17. The optoelectronic sensor in accordance with claim 10, wherein the measurement light beam is incident on the first optical metasurface at a first angle and the pilot light beam is incident on the first optical metasurface at a second angle with respect to an optical axis of the sensor, with amounts and/or directions of the first angle and of the second angle differing.

18. The optoelectronic sensor in accordance with claim 1, wherein the pilot light source transmits at least one pilot light beam in the wavelength range of 490 - 640 nm.
